(19) United States
(12) Patent Application Publication
(10) Pub. No.: US 2023/0329952 A1
(43) Pub. Date: Oct. 19, 2023

(54) SINGLE ARM SUPPORT DEVICE

(71) Applicant: BONE FOAM, INC., Corcoran, MN (US)

(72) Inventors: Benjamin J. Watters, III, Saint Louis Park, MN (US); Clinton J. McCullough, Blaine, MN (US); Peter A. Cole, JR., North Oaks, MN (US)

(21) Appl. No.: 18/136,139

(22) Filed: Apr. 18, 2023

Related U.S. Application Data
(60) Provisional application No. 63/332,011, filed on Apr. 18, 2022.

(51) Int. Cl. A61G 13/12

(52) U.S. Cl. CPC A61G 13/1235

(57) ABSTRACT

A patient positioning device for positioning a patient's arm in preparation for or during a surgical procedure. The device includes an arm support member and a strap, with the strap extending longitudinally relative to the arm support member. The arm support member includes an arm support surface and a bottom surface, with the arm support surface including a primary surface and secondary supports. The arm support member includes an arm support surface The secondary supports are configured to be wrapped about a patient's forearm. The strap has a fixed end fixed to the bottom surface of the arm support member and a free end extending longitudinally in a distal direction relative to the arm support member. The supporting member is configured to receive and retain the forearm of the patient in order to position the patient's arm using only the arm support device.

### CROSS REFERENCE TO RELATED APPLICATION

This Application claims the benefit of U.S. Provisional Application No. 63/332,011, filed Apr. 18, 2022, which is incorporated by reference in its entirety.

### BACKGROUND

Proper positioning of patients during and in preparation for surgery is extremely important in order to provide good operating conditions and effective access to the operative site. During surgery, patients may be placed in positions that are not completely physiologically stable or comfortable and need to be stabilized and maintained in such positions for extended periods of time. Improper positioning of the patient can lead to injury and potential disability and functional loss.

Several surgical procedures require the patient to be placed in a supine or “beach chair” (e.g., reclined sifting) position. During certain of these procedures, one or both arms may need to be supported and positioned so as not to fall within the operative field. The arm or arms are often taped and padded with an assortment of pillows, towels, tape, straps, buckles and/or other simple materials (see FIGS. 1A and 1B). This preparation takes up valuable time in the operating room and is not always successful. The inconsistency and variability of typical ad hoc setup procedures can put the patient at risk for soft tissue injuries and/or neuropathy.

Accordingly, there is an ongoing need for effective patient positioning devices. In particular, there is an ongoing need for support devices capable of effectively positioning a patient's arm during surgery in a consistent and safe manner and that also allow for easy and relatively rapid setup in the operating room.

### SUMMARY

Described herein are patient positioning devices configured for supporting and positioning a patient's arm in preparation for and/or during a surgical procedure. Arm support devices described herein can beneficially provide comfortable and effective support and positioning of a patient's arm in a safe manner and with efficient and simplified setup and use. By way of example and not limitation, arm support devices described herein may be utilized to support the arm(s) of a patient in a position outside of the operative field in surgical procedures where the patient is in a supine or beach chair position.

A patient positioning device for positioning a patient's arm in preparation for an anterior hip arthroplasty procedure or any surgical procedure or recovery in the supine or beach chair position (e.g., where the surgeon requires the operative side arm to be secured over the patient's chest) comprises a single arm support device. In some embodiments, the support device comprises an arm support member and a strap. The strap can extend longitudinally relative to the arm support member. The arm support member comprises an arm support surface and a bottom surface. The arm support surface comprises a primary surface and secondary supports, wherein the secondary supports are configured to be wrapped about the patient's forearm. The strap has a fixed end that is fixed to the bottom surface of the arm support member and a free end extending longitudinally in a distal direction relative to the arm support member. The arm support member is configured to receive and retain the forearm of the patient in order to easily and reliably position the patient's arm using only the arm support device.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, in which:

FIGS. 1A and 1B illustrate examples of a typical ad hoc approach to positioning an arm across the patient's torso for or during a surgical procedure;

FIG. 2 illustrates a patient lying in a supine position with an exemplary arm support device retaining the patient's right arm in a desired position.

FIG. 3 is a right, perspective view which illustrates an example arm support device;

FIG. 4 is a detailed top perspective view which illustrates an example of a textured support surface of the arm support device of FIG. 3;

FIGS. 5A and 5B are front end and back end views, respectively, of the arm support device of FIG. 3;

FIG. 6 is a top plan view of the arm support device of FIG. 3;

FIG. 7 is a bottom plan view of the arm support device of FIG. 3;

FIGS. 8A and 8B are left side and right side views, respectively, of the example arm support device of FIG. 3;

FIGS. 9-15 illustrate example steps of a method for utilizing the arm support device to restrain a patient's arm in a desired position.

### DETAILED DESCRIPTION

### Introduction

FIG. 1A and 1B illustrate examples of a typical ad hoc approach to positioning a patient's right arm or left arm, respectively, across the patient's torso during surgery, showing positioning of the right and left arms, respectively. As shown, a patient's arm is bent across the midline (via horizontal adduction of the shoulder) and secured in position on the patient's torso. This may be done to keep the arm out of the operative field. The surgical procedure may be related to the patient's shoulder region, other arm, side, neck, or other region of the body where it is beneficial to keep the arm secured and out of the way, for example.

FIG. 1A illustrates a patient's right arm that has been secured in position across the torso using a simple foam pad 10, which is cut to size and held in place using a length of surgical tape 12 wrapped around the foam pad 10 and the patient's arm and torso. An additional strap 14 is wrapped around the patient's torso and operating table or bed and tightened in place using one or more buckles 16.

FIG. 1B shows a different angle in which a patient's left arm has been secured in position across the torso using a simple foam pad 10 cut to size and held in place using surgical tape 12 wrapped around the foam pad 10 and the patient's arm and torso. An additional strap 14 is wrapped around the patient's torso and operating table or bed one or more times and tightened in place using buckles 16a and 16b.

Other off the shelf materials that are often used to secure a patient's arm include towels, pillows, rolled up bedsheets, and the like, all used in an ad hoc manner. This inconsistent approach is not standardized and can lead to improper positioning of the patient's arm. Improper positioning can result in soft tissue damage and/or neuropathy, particularly because the position may need to be maintained for relatively long periods of time while the patient is unconscious and unable to register impingements or other pain warnings.

Moreover, the non-standardized and ad hoc approach can waste valuable time in preparing the patient for the surgical procedure. Every additional minute in the operating room can increase personnel and resource costs. Thus, a standardized approach to arm positioning and a readily assembled device will provide significant cost savings and other benefits in addition to improvements in patient safety.

### Arm Support Device

FIG. 2 illustrates the use of an exemplary arm support device 100 to support and secure the right arm 18 of a patient 20 in a desired position. The same arm support device 100 can be reversed to support the patient's left arm if desired. Although the patient 20 is shown in a supine position, the support device 100 may be suitably used in other patient positions, such as the so-called “beach chair position” (e.g., partially sitting and reclining). Arm support devices described herein can beneficially provide effective support and positioning of a patient's arm in a safe and highly reproducible manner and with efficient setup and use.

Referring to FIGS. 3-10, the arm support device 100 more particularly includes an arm support member 104 and a strap 106 extending longitudinally from the arm support member 104. The arm support member 104 can have a criss-cross shape or configuration. The generally symmetrical shape of the arm support device 100 allow the arm support device 100 to be used interchangeably to support and restrain a patient's right arm or left arm.

The arm support member 104 has a support surface 112 and a bottom surface 110. The support surface 112 is adapted for comfortable placement and support of a patient's arm thereon (see FIG. 10). The support surface 112 can be made from a flexible, resilient, cushioning material (e.g., polyurethane foam, latex foam, Croslite (primarily polyethylene vinyl acetate), or other foam rubber), which can “pad” an arm placed on the support surface 112 of the arm support member 104.

The support surface 112 can comprise a primary elongated surface 120 and a number of secondary supports. The secondary supports can include an elongated posterior support 124 and first and second wings 122a, 122b. The primary elongated surface 120 is adapted receive a patient's forearm thereon (see FIG. 10). The forearm can be positioned on the primary elongated surface 120 so that the first and second wings 122a, 122b are distal to the patient's elbow in order to allow the wings 122a, 122b to be selectively wrapped around the patient's forearm and attached to each other, thereby securing the arm support device 100 to the patient's arm (see FIGS. 11 and 12).

The first and second wings 122a, 122b can include at least one fastening member 126 (e.g., adhesive tape or hook and loop system, e.g., Velcro) to provide for selective attachment of first wing 122a to second wing 122b. The fastening member 126 can be selectively attachable to the bottom surface 110 of the second wing 122b. In some embodiments, the fastening member 126 can be configured to mate with a complementary fastener 128 on the bottom surface 110 of the first wing 122a (see FIGS. 3, 6 and 7).

After securing the first and second wings 122a, 122b around the patient's forearm, the elongated posterior support 124 can be folded around the patient's elbow, above the patient's arm above the elbow, and then above the wings 122a, 122b to partially enclose and restrain the patient's elbow, upper arm, and upper part of the forearm in order to maintain proper positioning of the patient's arm in the supported and restrained position (see FIGS. 13-15).

As illustrated, the support surface 112 can be textured 114 to provide increased cushioning and facilitate airflow between the support surface 112 and the patient's arm, which helps regulate temperature and prevent overheating or skin irritation. As more particularly see in in FIG. 4, the texture 114 can be a repeating pattern, such as the “egg carton” pattern illustrated in the Figures. The texture 114 can also be an irregular pattern. The texture 114 can comprise grooves 116 that separate peaks 118, with the grooves 116 facilitating airflow between the support surface 112 and an arm placed thereon and wrapped therewithin. The support surface 112 can be made of a cushioning material such as polyethylene foam, polyurethane foam, latex foam, reticulated foam, Croslite (primarily polyethylene vinyl acetate), and the like.

The bottom surface 110 of the arm support member 104 can include a strap 106 and a fastening member 130 (see FIGS. 3, 6 and 7). The fastening member 130 may comprise hook and loop fastener components, clasps, buckles, or other fastening hardware or means known in the art. The fastening member 130 can be configured to attach to an external surface or device (not shown), such as the bottom of the operating table or bed (see FIG. 15).

As seen in FIG. 7, the strap 106 can have a fixed end 108a, which can be fixed to the bottom surface 110 of the arm support member 104, and a free end 108b extending in a distal direction relative to the arm support member 104. The connection of the strap 106 to the bottom surface 110 of the arm support member 104 can allow a user to wrap the elongated posterior support 124 around the elbow and upper arm of the patient and then across the patient's body to position the patient's arm in the desired position (see FIGS. 10-15).

The strap 106 is designed to permit operating room staff to apply arm traction by pulling on the strap 106. For example, pulling the strap in the distal direction (i.e., the direction extending along the arm toward the hand and beyond) pulls the elongated posterior support 124 distally against the patient's upper arm to secure the upper arm and prevent it from falling posteriorly (i.e., prevent horizontal abduction of the shoulder).

The bottom surface 110 and support surface 112 may be formed from the same or from different materials. Preferably, the bottom surface 110 and/or support surface 112 are formed from a polymer foam material, such as an open or closed cell foam, a “memory foam” (e.g., low-resilience polyurethane foam and/or other viscoelastic foams), rubber materials, gel padding, or combinations thereof. Some embodiments may also include a water-resistant coating, such as a flexible, water-resistant polymer (e.g., vinyl-based) that coats the foam material and allows for easy cleaning of the device.

FIGS. 9-15 illustrate an example method of using the arm support device 100 to comfortably and reliably secure and restrain a patient's arm in a desired position. First, the arm support device 100 is positioned across the patient's chest with the first and second wings 122a, 122b lining up with the shoulder of the arm (e.g., right shoulder and arm as illustrate) to be supported in the device 100 (FIG. 9).

Next, the patient's forearm is placed on the primary elongated surface 120 of the support surface 112, with the first and second wings 122a, 122b positioned medial relative to the patient's upper arm when the forearm is placed on the arm support device 100 across the patient's torso (FIG. 10).

Next, first wing 122a can be folded upward, toward the patient's head and around the forearm (FIG. 11), placing the fastener 128 in an exposed configuration. Then, second wing 122b can be folded downward, and the overlapping second wing 122b and fastening member 126 can be selectively attached to the fastener 128 on underlying first wing 122a (FIG. 12). The arm support device 100 is now attached to the patient's forearm.

Thereafter, a medical practitioner can pull the strap 106 in a distal direction (i.e., the direction extending along the arm toward the hand or opposite arm) in order to pull the posterior support 124 in a distal direction, causing the elongated posterior support 124 to be wrapped around the patient's elbow, upper arm, and forearm beneath the interconnected wings 122a, 122b to secure the patient's arm in the desired position and prevent it from falling posteriorly (i.e., prevent horizontal abduction of the shoulder). The strap 106 can then be secured to a stretcher or tabletop support on an operating table to maintain the arm in the desired position.

### CONCLUSION

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, or less than 1% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an,” and “the” do not exclude plural referents unless the context clearly dictates otherwise. Thus, for example, an embodiment referencing a singular referent (e.g., “widget”) may also include two or more such referents.

It will also be appreciated that embodiments described herein may include properties, features (e.g., ingredients, components, members, elements, parts, and/or portions) described in other embodiments described herein. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. An arm support device, comprising:
an arm support member; and
a strap extending longitudinally relative to the arm support member,
wherein the arm support member comprises an arm support surface and a bottom surface, the arm support surface comprising a primary elongated surface and secondary supports, the secondary supports configured to be wrapped about a patient's forearm;
wherein the secondary supports comprise a first wing and a second wing extending laterally in opposing directions from the primary elongated surface, and an elongated posterior support extending in a proximal direction relative to an arm of a patient;
wherein the strap has a fixed end, which is fixed to the bottom surface of the arm support member and a free end extending longitudinally in a distal direction relative to the arm support member; and
wherein the arm support member is configured to receive and retain the forearm of the patient in order to place and retain the patient's arm in a desired position.

2. The arm support device of claim 1, wherein the arm support surface is formed of a flexible foam-like material.

3. The arm support device of claim 1, wherein the arm support surface includes a textured surface.

4. The arm support device of claim 3, wherein the textured surface comprises a repeating pattern forming peaks and grooves that promote airflow.

5. The arm support device of claim 3, wherein the textured surface comprises an egg carton configuration.

6. The arm support device of claim 1, wherein the arm support device is symmetrical in shape in at least one direction.

7. The arm support device of claim 1, wherein at least one of the secondary supports includes a first fastening member.

8. The arm support device of claim 6, wherein at least one of the secondary supports includes a second fastening member configured to mate with the first fastening member.

9. The arm support device of claim 8, wherein first and second fastening members comprise a hook and loop system.

10. A method of applying the arm support device of claim 1 to a patient's arm, the method comprising:
placing the arm support member across the patient's torso;
placing the patient's forearm on the arm support surface;
folding the first wing over the patient's forearm;
folding the second wing over the patient's forearm;
selectively attaching a fastener of the second wing to a bottom surface of the first wing;
pulling the strap in a distal direction across the patient's torso in order to move the arm into a desired position; and
securing the strap to a stretcher or operating table to maintain the desired position of the arm.

11. The method of claim 10, wherein the method comprises using the arm support device to place and retain the patient's left arm in a desired position.

12. The method of claim 10, wherein the method comprises using the arm support device to place and retain the patient's right arm in a desired position.

13. The method of claim 10, wherein the method comprises using a first arm support device to place and retain the patient's left arm in a desired position and a second support device to place and retain the patient's right arm in a desired position

14. The method of claim 10, further comprising moving the strap into a different position in order to reposition the patient's arm.

15. The method of claim 10, wherein the arm support surface is formed of a flexible foam-like material.

16. The method of claim 10, wherein the arm support surface includes a textured surface.

17. The method of claim 16, wherein the textured surface comprises a repeating pattern forming peaks and grooves that promote airflow.

18. The method of claim 16, wherein the textured surface comprises an egg carton configuration.

19. An arm support device, comprising:
an arm support member form from a flexible foam-like material; and
a strap extending longitudinally relative to the arm support member,
wherein the arm support member comprises a textured arm support surface and a bottom surface, the textured arm support surface comprising a primary elongated surface and secondary supports, the secondary supports configured to be wrapped about a patient's forearm;
wherein the secondary supports comprise a first wing and a second wing extending laterally in opposing directions from the primary elongated surface, and an elongated posterior support extending in a proximal direction relative to an arm of a patient;
wherein the strap has a fixed end, which is fixed to the bottom surface of the arm support member and a free end extending longitudinally in a distal direction relative to the arm support member; and
wherein the arm support member is configured to receive and retain the forearm of the patient in order to place and retain the patient's arm in a desired position.

20. The arm support device of claim 19, wherein the textured arm support comprises an egg carton configuration.
